(19) United States
(12) Patent Application Publication
(10) Pub. No.: US 2015/0040559 A1
(43) Pub. Date: Feb. 12, 2015

(54) INTAKE COOLER FOR INTAKE-EXHAUST GAS HANDLING SYSTEM

(71) Applicant: Denso International America, Inc., Southfield, MI (US)

(72) Inventor: Patrick Powell, Farmington Hills, MI (US)

(73) Assignee: Denso International America, Inc., Southfield, MI (US)

(21) Appl. No.: 13/961,069

(22) Filed: Aug. 7, 2013

(51) Int. Cl. F02M 25/07; F02M 31/20

(52) U.S. Cl. CPC F02M 25/072; F02M 31/20
USPC 60/599; 123/542

(57) ABSTRACT

An intake-exhaust gas handling system for an internal combustion engine includes an intake system, an exhaust system, an intake cooler, and an exhaust gas recirculation (EGR) system. The intake system provides an intake charge, which can be a mixture of exhaust gas and air, to the internal combustion engine. The exhaust system removes exhaust gas generated by the internal combustion engine after a combustion process. The intake cooler can be disposed at the intake system for cooling the intake charge prior to its discharge into the internal combustion engine. The EGR system routes exhaust gas from the exhaust system to the intake system, where it is mixed with air at a position upstream of the intake cooler.

### FIELD

The present disclosure relates to an intake-exhaust gas handling system having an intake cooler for cooling an intake charge, which is introduced to an internal combustion engine.

### BACKGROUND

The statements in this section merely provide background information related to the present disclosure and may not constitute prior art.

Internal combustion engines function by burning fuels (hydrocarbons) at high temperatures. In theory, the products of the combustion process are CO₂ and water. It is not uncommon for an incomplete combustion to occur which results in the formation of undesirable byproducts such as carbon monoxide, hydrocarbons and soot. Other reactions occurring in the internal combustion engine may also produce nitrogen oxide.

To reduce the emission of nitrogen oxide, an intake-exhaust gas handling system for an internal combustion engine can include an exhaust gas recirculation (EGR) system. The EGR system can redirect exhaust gas, after a combustion process, from an exhaust system to an intake system of the intake-exhaust gas handling system. By adding exhaust gas to air flowing in the intake system, the temperature at which the combustion occurs reduces which, as a result, reduces the content of nitrogen oxide in the exhaust gas.

To control the temperature at which the exhaust gas and air are provided to the internal combustion engine, both the EGR system and the intake system include a cooler for separately cooling the exhaust gas and air before they are mixed and ultimately introduced into the internal combustion engine. By having such configuration, the intake-exhaust gas handling system can become complex and costly.

### SUMMARY

This section provides a general summary of the disclosure, and is not a comprehensive disclosure of its full scope or all of its features.

The present disclosure provides for an intake-exhaust gas handling system for an internal combustion engine. The system includes an intake system, an exhaust system, an intake cooler, and an exhaust gas recirculation (EGR) system. The intake system provides an intake charge, which is a mixture of exhaust gas and air, to the internal combustion engine. The exhaust system removes exhaust gas generated by the internal combustion engine after a combustion process. The intake cooler can be disposed at the intake system for cooling the intake charge prior to its discharge into the internal combustion engine. The EGR system routes exhaust gas from the exhaust system to the intake system, where it is mixed with air flowing in the intake system. The EGR system can be disposed between the exhaust system and the intake system, at a position upstream of the intake cooler, thereby cooling the mixture of exhaust gas and air by a single cooler, the intake cooler.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic view of a vehicle power system including an exhaust gas recirculation (EGR) system in a first embodiment of the present disclosure;

FIG. 2 is a schematic view of the vehicle power system including an EGR system in a second embodiment of the present disclosure;

FIG. 3 is a schematic view of the vehicle power system including an EGR system in a third embodiment of the present disclosure;

FIG. 4 is a schematic view of the vehicle power system including an EGR system in a fourth embodiment of the present disclosure;

FIG. 5 is a schematic view of a turbo-charger having a turbine and a compressor of the vehicle power system;

FIG. 6 is a schematic view of an EGR system provided along a housing of the turbo-charger of FIG. 5 in a fifth embodiment of the present disclosure;

FIG. 7 is a schematic view of an EGR system provided along the housing of the turbo-charger of FIG. 5 in a sixth embodiment of the present disclosure;

FIG. 8 is a schematic view of an EGR system provided along the housing of the turbo-charger of FIG. 5 in a seventh embodiment of the present disclosure;

FIG. 9 is a schematic view of an EGR system provided along the housing of the turbo-charger of FIG. 5 in a eighth embodiment of the present disclosure; and

FIG. 10 is a schematic view of an EGR system provided within a turbo-charger of the vehicle power system in a ninth embodiment of the present disclosure.

Corresponding reference numerals indicate corresponding parts throughout the several views of the drawings.

### DETAILED DESCRIPTION

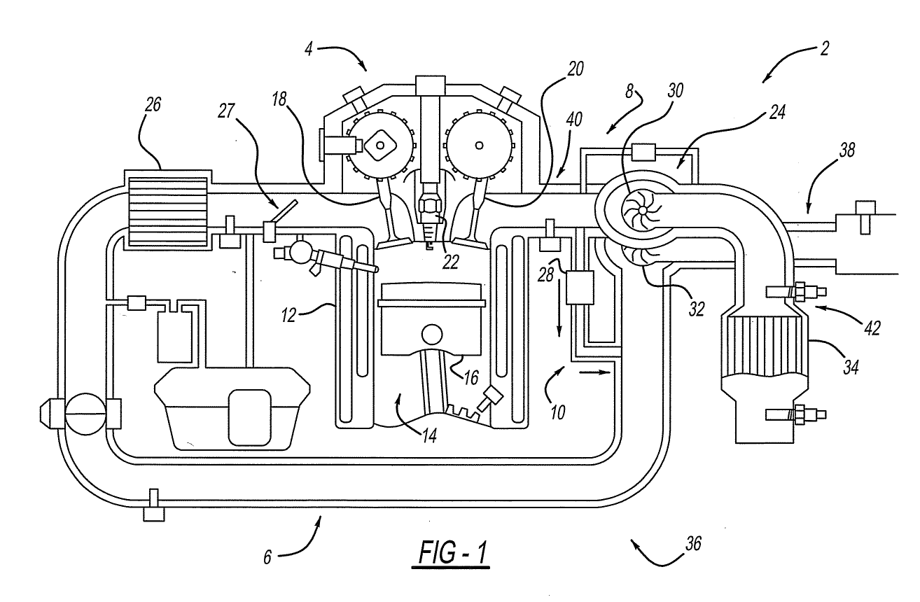

Example embodiments will now be described more fully with reference to the accompanying drawings. With reference to FIG. 1 a vehicular power system 2 of a vehicle includes an internal combustion engine 4 and an intake and exhaust gas handling system in the form of an intake system 6, an exhaust system 8, and an exhaust gas recirculation (EGR) system 10.

The internal combustion engine 4 includes an engine block 12 defining a plurality of cylinders 14. A piston 16 is slidingly received within each cylinder 14. An intake valve 18 opens into each cylinder 14 to provide an intake charge and an exhaust valve 20 opens into each cylinder 14 to expel the products of combustion. A fuel injector 22 is disposed in each cylinder 14 to supply fuel for the combustion process. As is well known in the art, the motion of the piston is synchronized with the opening and closing of the intake valve 18, the opening and closing of the exhaust valve 20 and the supplying of fuel from the fuel injector 22 such that the internal combustion engine 4 runs to provide power to operate the vehicle. In diesel engines a glow plug can be provided in each cylinder 14, as is well known in the art, and in a gasoline engine a spark plug or other means for initiating the combustion process can be disposed in each cylinder 14, as is well known in the art.

The intake system 6, through which outside air is provided to the internal combustion engine 4, can include a turbo-charger 24 which increases the pressure of the air being supplied to the internal combustion engine 4. In addition, an intake cooler 26 cools the intake charge being supplied to the internal combustion engine 4, and a throttle valve 27 controls the flow of the intake charge to the internal combustion engine 4.

The intake cooler 26 can be an intercooler, and/or a charged air cooler (CAC), that lowers the temperature of the mixture of exhaust gas and compressed air before it is provided to the internal combustion engine 4. The intake cooler 26 can have various configurations, such as an air-to-air or air-to-liquid heat exchange device.

The EGR system 10 receives exhaust gas from the exhaust system 8 and routes the exhaust gas back into the intake system 6 at a position upstream of the intake cooler 26. The EGR system 10 includes a control valve 28, which controls the flow of exhaust gas through the EGR system 10 based upon a control program provided in the vehicle's engine control module (not shown).

The exhaust system 8 is routed through the turbo-charger 24 where the exhaust gas powers a turbine 30 which in turn powers a compressor 32 which increases the pressure of the air supplied to the internal combustion engine 4. After leaving the turbine 30 of the turbo-charger 24, the exhaust system 8 is routed through a particulate filter 34 (for diesel applications) and it is then routed to a muffler and possibly a catalytic converter prior to being released to the atmosphere.

The intake system 6 can be viewed as having a high pressure intake (HP-I) 36 and a low pressure intake (LP-1) 38. In particular, outside air flows through the LP-I 38 and then through the turbo-charger 24 where the compressor 32 increases its pressure. Compressed air then flows into the HP-I 36 to ultimately be supplied to the internal combustion engine 4.

Similarly, the exhaust system 8 can be viewed as having a high pressure exhaust (HP-E) 40 and a low pressure exhaust (LP-E) 42. After a combustion process, high pressured exhaust gas flows through the HP-E 40 and then the turbo-charger 24, where it turns the turbine 30. The exhaust gas then flows into the LP-E 42 to ultimately be released into the atmosphere.

In a first embodiment, the EGR system 10, as shown in FIG. 1, routes some of the exhaust gas from the exhaust system 8 to the intake system 6 upstream of the intake cooler 26. Specifically, the EGR system 10 routes the exhaust gas from the HP-E 40 to the HP-I 36, such that after the combustion process high pressure exhaust gas travels into the EGR system 10 to mix with compressed air leaving the compressor 32 of the turbo-charger 24 (as indicated by the arrows in FIG. 1). The intake charge, which now includes a mixture of exhaust gas and compressed air, is then cooled by the intake cooler 26.

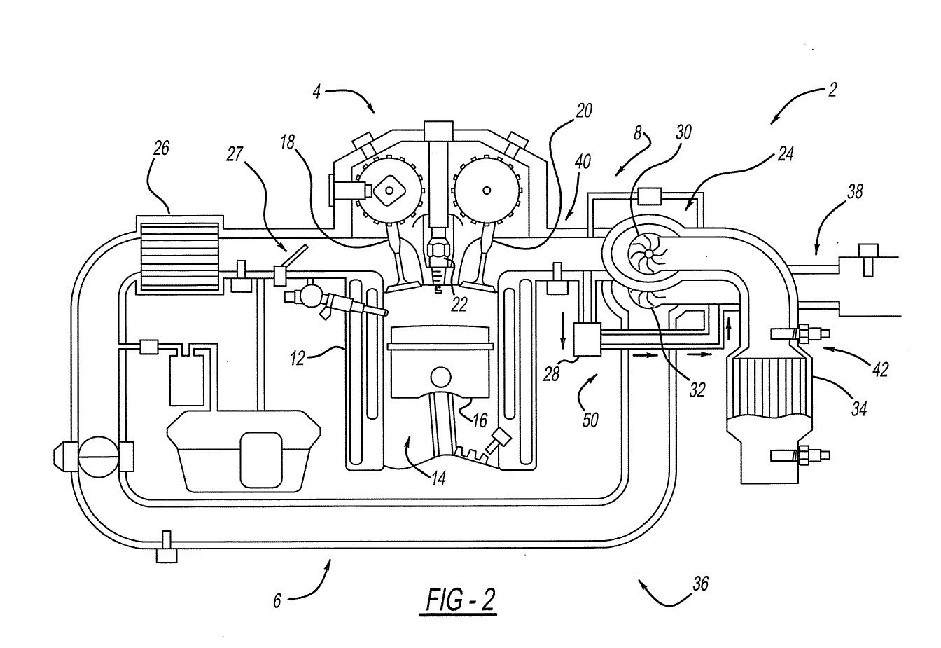

In a second embodiment, as shown in FIG. 2, the vehicle power system 2 includes an EGR system 50 that routes exhaust gas from the HP-E 40 to the LP-I 38, such that after the combustion process high pressure exhaust gas travels into the EGR system 50 to mix with the air upstream of the turbo-charger 24 (as indicated by the arrows in FIG. 2). The mixture of exhaust gas and air then flows into the compressor 32 of the turbo-charger 24, where the mixture is compressed before entering the intake cooler 26, and, ultimately, the internal combustion engine 4 as the intake charge.

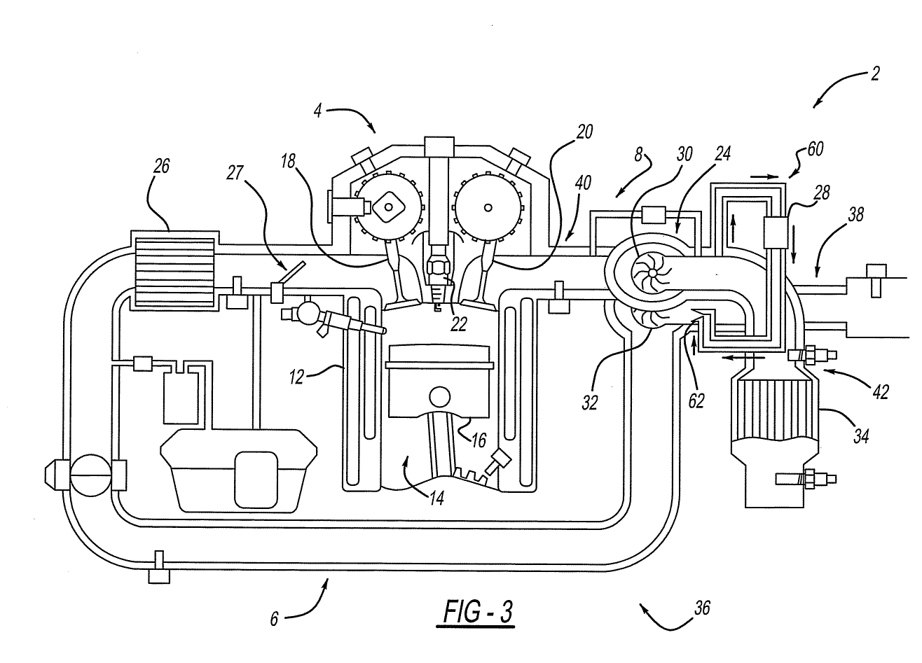

The EGR system 10 of FIG. 1 and the EGR system 50 of FIG. 2 utilize the high pressure of the exhaust gas in the HP-E 40 to propel the exhaust gas into the EGR systems 10, 50, where the control valve 28 controls the flow of the exhaust gas into the intake system 6. Alternatively, some of the exhaust gas flowing in LP-E 42 of the exhaust system 8 can be routed into the intake system 6 to mix with the air flowing therein at a position upstream of the intake cooler 26. For instance, in a third embodiment, as shown in FIG. 3, an EGR system 60 routes exhaust gas from LP-E 42 to LP-I 38, such that some of the exhaust gas exiting from the turbine 30 of the turbo charger 24 flows into the EGR system 60 to mix with the air in the LP-I 38 (as indicated by the arrows in FIG. 3).

To ensure proper flow of the exhaust gas, the EGR system 60 can include the control valve 28 to control the flow of exhaust gas entering the intake system 6 and a funnel 62 to draw exhaust gas from the LP-E 42. The funnel 62 of the EGR system 60 can be disposed within the LP-I 42. As known in the art, the funnel 62 constricts a flow path for the air flowing from the compressor 32. As the air flows through the constricted flow path, a vacuum pocket is created at an end of the funnel 62 which draws the exhaust gas from the EGR system 60. The mixture of exhaust gas and air then flows into the compressor 32 of the turbo-charger 24, where the mixture is compressed before entering the intake cooler 26, and, ultimately, the internal combustion engine 4 as the intake charge.

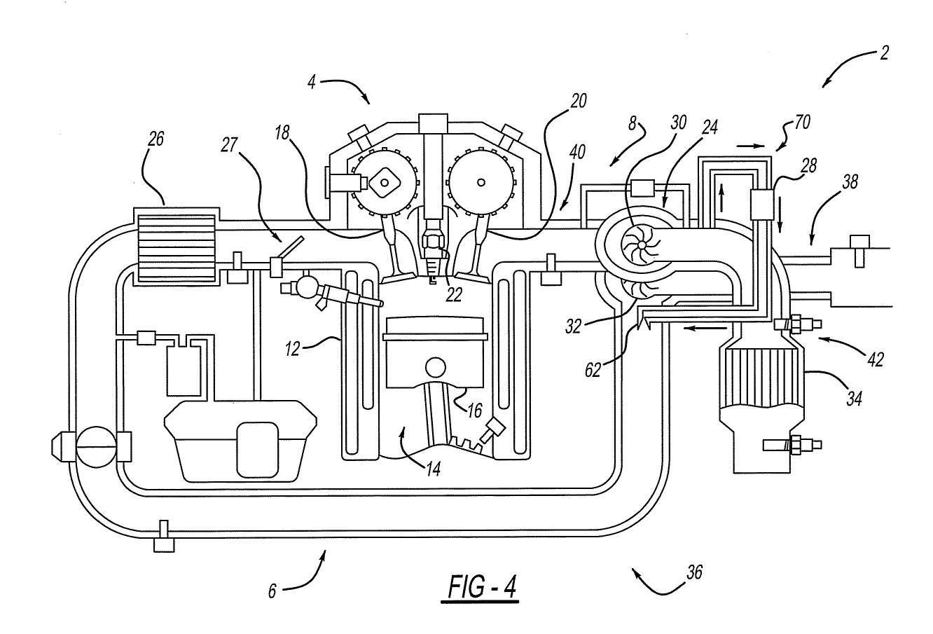

In a fourth embodiment, as shown in FIG. 4, the vehicle power system 2 includes an EGR system 70 that routes exhaust gas from LP-E 42 to HP-I 36, such that some of the exhaust gas exiting from the turbine 30 flows into the EGR system 70 to mix with compressed air leaving the compressor 32 (as indicated by the arrows in FIG. 4). To ensure proper flow of the low pressure exhaust gas, the funnel 62, which can be disposed at the HP-I 36, draws the exhaust gas from the EGR system 70 to the HP-I 36. The mixture of exhaust gas and compressed air then flows into the intake cooler 26 and, ultimately, the internal combustion engine 4 as the intake charge.

The EGR systems 10, 50, 60, 70 of FIGS. 1-4, respectively, can be implemented using exhaust pipe routed through the vehicle power system 2. In the vehicle power systems 2 of FIGS. 1-4, the EGR systems 10, 50, 60, 70 redirect exhaust gas from the exhaust system 8 to the intake system 6, where the exhaust gas mixes with the air upstream of the intake cooler 26. The mixture of exhaust gas and air are then cooled by the same cooler, the intake cooler 26. The vehicle power system 2 utilizes a single cooler to cool the exhaust gas and the air, thereby eliminating the need for a separate cooler for the EGR system, thus reducing the cost and complexity of the intake-exhaust gas handling system of the vehicle power system 2.

By utilizing the high pressure of the exhaust gas flowing in the HP-E 40, the EGR system 10 of the first embodiment and the EGR system 50 of the second embodiment may not require the funnel 62 to draw the exhaust gas into the intake system 6. Therefore, the EGR systems 10, 50 may be cheaper and less complex than the EGR systems 60, 70 of the third and fourth embodiments.

Furthermore, the EGR system 10 of the first embodiment and the EGR system 70 of the fourth embodiment route the exhaust gas to the HP-I 32 of the intake system 6 at a position upstream of the intake cooler 26. Accordingly, the exhaust gas, which has corrosive properties, does not flow through the compressor 32 of the turbo-charger 24. Since, the EGR systems 50, 60 of the second and third embodiments, respectively, route the exhaust gas to the LP-I 42 of the intake system 6, the compressor 32 may require anti-corrosive properties or a special treatment for preventing corrosion.

In a fifth and sixth embodiment, EGR systems of the intake-exhaust gas handling system is configured along a housing of the turbo-charger 24 to direct exhaust gas from the exhaust system 8 to the intake system 6 upstream of the intake cooler 26.

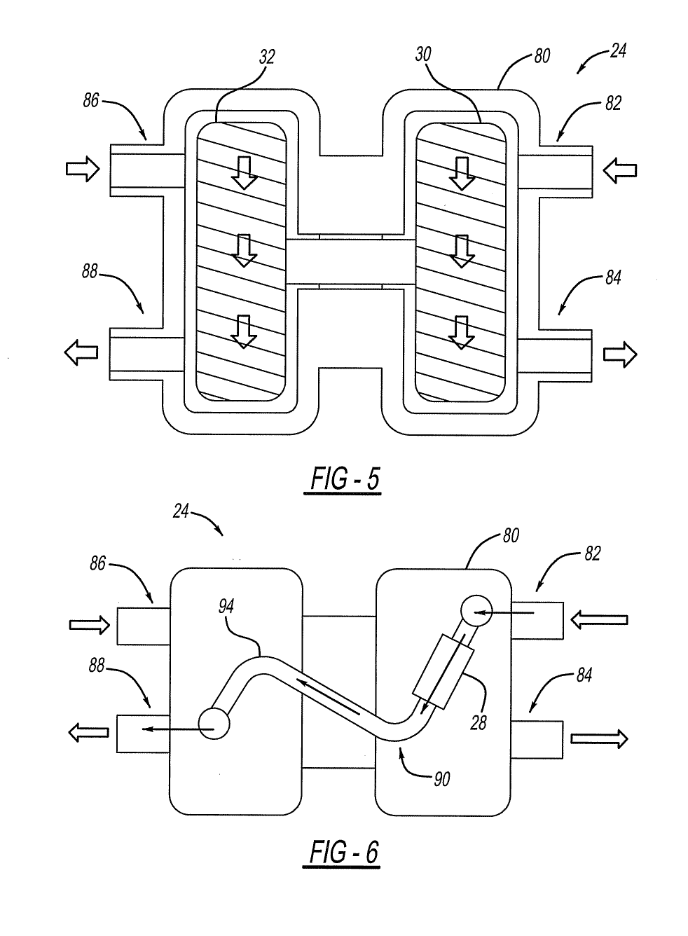

By way of explanation, the turbo-charger 24, as illustrated in FIG. 5, includes the turbine 30, the compressor 32, and a housing 80. The housing 80 defines an exhaust inlet 82, an exhaust outlet 84, an air inlet 86, and an air outlet 88. The exhaust inlet 82 can be coupled to the HP-E 40 of the exhaust system 8, and the exhaust outlet 84 can be coupled to the LP-E 42 of the exhaust system 8. The air inlet 86 can be coupled to the LP-I 38 of the intake system 6, and the air outlet 88 can be coupled to the HP-I 36 of the intake system 6. Accordingly, after the combustion process, exhaust gas from the HP-E 40 can travel into the turbo-charger 24 via the exhaust inlet 82 to turn the turbine 30, and exits to the LP-E 42 via the exhaust outlet 84. The air flowing from the LP-I 38 enters the compressor 32 via the air inlet 86, where the compressor 32 increases the pressure of the air as it is being rotated by the turbine 30. The compressed air then flows into the HP-I 36 via the air outlet 88. The arrows of FIG. 5 represent the flow of exhaust gas and air within the turbo-charger 24.

An EGR system 90 of the fifth embodiment, shown in FIG. 6, is coupled to the housing 80 of the turbo-charger 24, and includes the control valve 28 and a tubing 94. The tubing 94 extends from a region of the turbo-charger 24 close to the exhaust inlet 82 to a region of the turbo-charger 24 close to the air outlet 88. The control valve 28 can be disposed along the tubing 94 to control the flow of exhaust gas into the intake system 6.

As exhaust gas enters the turbo-charger 24 from the HP-E 40, a portion of the exhaust gas enters the EGR system 90 to combine with compressed air flowing through the compressor 32. The mixture of exhaust gas and compressed air flows out the air outlet 88 to the HP-I 36 of the intake system 6, where it is cooled by the intake cooler 26 before entering the internal combustion engine 4.

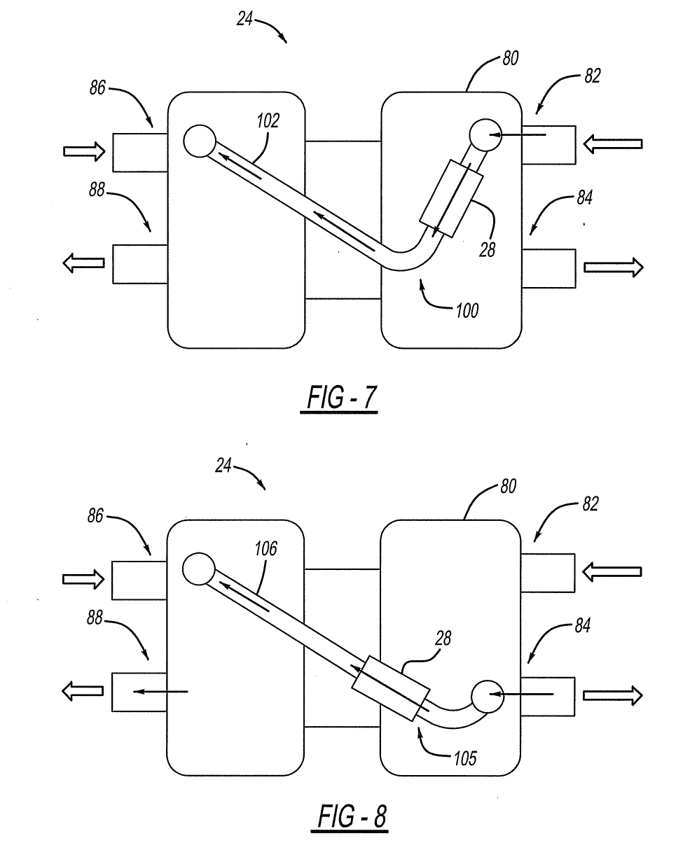

In another configuration, as illustrated in FIG. 7, an EGR system 100 of the sixth embodiment includes the control valve 28 disposed along a tubing 102 to control the flow of exhaust gas through the EGR system 100. The tubing 102 can extend from a region of the turbo-charger 24 close to the exhaust inlet 82 to a region of the turbo-charger 24 close to the air inlet 86.

As high pressured exhaust gas from the HP-E 40 enters the turbo-charger 24, a portion of the exhaust gas flows through the EGR system 100 to mix with the air entering the compressor 32 from the LP-I 38 of the intake system 6. The mixture of exhaust gas and air flows through the compressor 32 where the pressure of the mixture increases, and then flows out into the HP-I 36 of the intake system 6, where it is cooled by the intake cooler 26 before entering the internal combustion engine 4.

Per the fifth and sixth embodiments, the EGR systems 90, 100, like the EGR systems 10, 50, 60, 70 of the first to fourth embodiments, transfer exhaust gas from the exhaust system 8 to the intake system 6, where it is mixed with the air of the intake system 6 at a position upstream of the intake cooler 26. Thus, the mixture of exhaust gas and air are then cooled together by the intake cooler 26.

The EGR systems 90, 100 of the fifth and sixth embodiments, respectively, transfers exhaust gas flowing close to the exhaust inlet 82 to the intake system 6 by way of the compressor 32. In another configuration the EGR system can transfer exhaust gas flowing close to the exhaust outlet 84 to the intake system 6. For instance FIG. 8 illustrates an EGR system 105 of a seventh embodiment. The EGR system 105 can include the control valve 28 arranged along a tubing 106 which extends from a region of the turbo-charger 24 close to the exhaust outlet 84 to a region of the turbo-charger 24 close to the air inlet 86. Accordingly, as exhaust gas flows through the turbine 30, a portion of the exhaust gas enters the EGR system 105 to mix with the air entering the compressor 32.

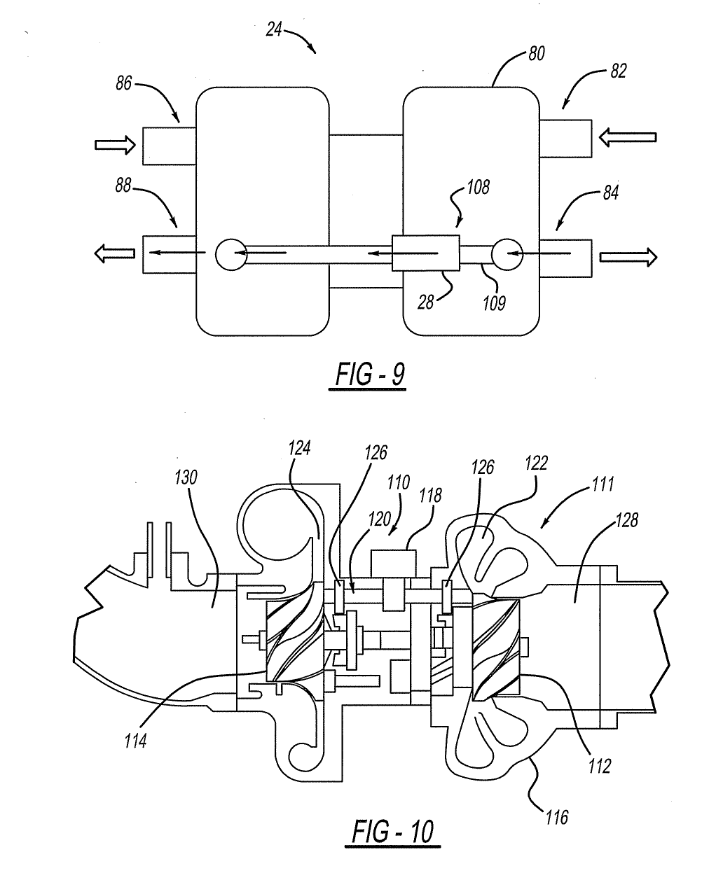

In another configuration, as shown in FIG. 9, an EGR system 108 of an eighth embodiment can include the control valve 28 arranged along a tubing 109 which can extend from a region of the turbo-charger 24 close to the exhaust outlet 84 to a region of the turbo-charger 24 close to the air outlet 88. Accordingly, as exhaust gas flows through the turbine 30, a portion of the exhaust gas enters the EGR system 108 to mix with the compressed air flowing through the compressor 32.

The EGR system 90, 100 of the fifth and sixth embodiment, as shown in FIGS. 6 and 7, respectively, utilize the high pressure of the exhaust gas entering the turbo-charger 24 to propel the exhaust gas into the tubing 94, 102. The EGR systems 105, 108 of the seventh and eighth embodiment may include a funnel to create a vacuum pocket for drawing the exhaust gas towards the compressor 32.

The configuration of the EGR systems 105, 108 may also be utilized as an air pump system to eject air from the intake system 6 into the exhaust system 8. Specifically, the air flowing in the compressor 32 may have a higher pressure than the exhaust gas flowing near the exhaust outlet 84 of the turbo-charger 24. The air pump system can be provided to have a tubing that couples a region of the turbo-charger 24 close to the air inlet 86 to a region of the turbo charger 24 close to the exhaust outlet 84 (similar to tubing 106). Alternatively, the air pump system can be provided to have a tubing that couples a region of the turbo-charger 24 close to the air outlet 88 to a region of the turbo charger 24 close to the exhaust outlet 84 (similar to tubing 109). A control valve can be disposed along the tubing of the air pump system to control the flow of air into the turbine 30 and, ultimately, into the exhaust system 8.

The air injected into the exhaust system 8 assists in warming the catalyst quicker, thereby burning unburned hydrocarbons which can otherwise escape into the exhaust stream. It should be understood, that if the air pump system is configured along the housing 80 of the turbo-charger 24, the intake-exhaust gas handling system would include an EGR system having a configuration different from the EGR system 105 and the EGR system 108. For example, any one of the EGR systems 10, 50, 60, 70 can be used with the air pump system which is configured along the housing 80 of the turbo-charger 24.

In a ninth embodiment of the present disclosure, the vehicle power system 2 can include an EGR system 110, as illustrated in FIG. 10, which can be provided within a turbo-charger 111 to provide exhaust gas to the intake system 6. The turbo-charger 111 performs in the same manner as the turbo-charger 24, and includes a turbine 112, a compressor 114, and a housing 116.

The EGR system 110 includes a control valve 118 to control the flow of exhaust gas into the intake system 6 via a flow channel 120. The flow channel 120 can be formed inside of the housing 116 of the turbo-charger 111 and can bridge a side of the housing 116 close to an exhaust inlet 122 to a side of the housing 116 close to an air outlet 124. The control valve 118 can be, for example, threaded into the housing 116. In addition, seals 126 can be disposed along the flow channel 120 to prevent leakage of exhaust gas and/or air.

As high pressured exhaust gas enters the turbo-charger 111 to rotate the turbine 112, some of the exhaust gas flows through the EGR system 110, as controlled by the control valve 118, and the remaining exhaust gas flows into the LP-E 42 from an exhaust outlet 128. The flow channel 120 directs the exhaust gas to the compressor 114 side of the turbo-charger 111 to mix with air flowing through the compressor 114 from an air inlet 130. The mixture of exhaust gas and air flows through the air outlet 124 where it is provided to the HP-I 36 of the intake system 6. The mixture can then be cooled by the intake cooler 26 before entering the internal combustion engine 4 as the intake charge.

The EGR system 110 of the ninth embodiment directs the flow of exhaust gas from the exhaust system 8 to the intake system 6 at a position upstream of the intake cooler 26. The intake-exhaust gas handling system of the vehicle power system 2 utilizes a single cooler for both the exhaust gas and theair, thereby reducing the overall cost of the vehicle power system 2. In addition, by having the EGR system 110 configured within the turbo-charger 111, the overall complexity related to the packaging of the vehicle power system 2 may also be simplified.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

What is claimed is:

1. An intake-exhaust gas handling system for an internal combustion engine comprising:
an exhaust system removing exhaust gas after a combustion process performed by the internal combustion engine;
an intake system providing an intake charge to the internal combustion engine, wherein the intake charge is a mixture of the exhaust gas and air;
an intake cooler disposed along the intake system and decreasing a temperature of the intake charge prior to the intake charge being provided to the internal combustion engine; and
an exhaust gas recirculation EGR system disposed between the exhaust system and the intake system and routing the exhaust gas from the exhaust system to the intake system upstream of the intake cooler.

2. The intake-exhaust gas handling system of claim 1, wherein the EGR system is arranged between a high pressure exhaust section of the exhaust system and a high pressure intake section of the intake system, and upstream of the intake cooler.

3. The intake-exhaust gas handling system of claim 1, wherein the EGR system is arranged between a high pressure exhaust section of the exhaust system and a low pressure intake section of the intake system, and upstream of the intake cooler.

4. The intake-exhaust gas handling system of claim 1, wherein the EGR system is arranged between a low pressure exhaust section of the exhaust system and a high pressure intake section of the intake system, and upstream of the intake cooler.

5. The intake-exhaust gas handling system of claim 1, wherein the EGR system is arranged between a low pressure exhaust section of the exhaust system section and a low pressure intake section of the intake system, and upstream of the intake cooler.

6. The intake-exhaust gas handling system of claim 1 further comprising:
a turbo-charger including a turbine and a compressor housed in a housing and positioned between the exhaust system and the intake system and upstream of the intake cooler, the turbine rotating the compressor by exhaust gas flowing through the turbine from the exhaust system and the compressor increasing a pressure of air flowing therein from the intake system, wherein
the EGR system is arranged outside of the housing of the turbo-charger to provide the exhaust gas flowing through the turbine to air flowing through the compressor.

7. The intake-exhaust gas handling system of claim 6, wherein the EGR system is arranged outside of the housing between an exhaust inlet of the housing, through which the exhaust gas enters the turbine, and an air inlet of the housing, through which air enters the compressor.

8. The intake-exhaust gas handling system of claim 6, wherein the EGR system is arranged outside of the housing between an exhaust inlet of the housing, through which the exhaust gas enters the turbine, and an air outlet of the housing, through which air leaves the compressor.

9. The intake-exhaust gas handling system of claim 1 further comprising:
a turbo-charger including a turbine and a compressor housed in a housing and positioned between the exhaust system and the intake system and upstream of the intake cooler, wherein
the EGR system defines a channel within the housing of the turbo-charger and includes a control valve disposed at the turbo-charger, the channel extends from the turbine to the compressor with the control valve provided along the channel to provide exhaust gas flowing through the turbine to air flowing through the compressor.

10. The intake-exhaust gas handling system of claim 1 further comprising:
a turbo-charger including a turbine and a compressor housed in a housing and positioned between the exhaust system and the intake system and upstream of the intake cooler, the turbine rotating the compressor by exhaust gas flowing through the turbine from the exhaust system, and the compressor increasing a pressure of air flowing therein from the intake system; and
an air-pump system injecting air into the exhaust system and including a control valve arranged along a tubing, the tubing coupled to the housing of the turbo-charger and introducing air from the compressor to the turbine.
